(19) United States
(12) Patent Application Publication
(10) Pub. No.: US 2012/0217083 A1
(43) Pub. Date: Aug. 30, 2012

(54) STEERING CONTROL SYSTEM HAVING SPEED-BASED CENTERING

(76) Inventor: Chad T. Brickner, Aurora, IL (US)

(21) Appl. No.: 13/036,326

(22) Filed: Feb. 28, 2011

(51) Int. Cl. B62D 5/04; B62D 5/06

(52) U.S. Cl. 180/417; 180/443

(57) ABSTRACT

A steering control system for a machine having a traction device is disclosed. The steering control system may have a steering actuator, and a steering sensor configured to generate a first signal indicative of an actual steering angle of the machine. The steering control system may also have an operator input device, an input sensor configured to generate a second signal indicative of desired steering of the machine, and a feedback actuator operatively connected to the operator input device. The steering control system may further have a travel speed sensor configured to generate a third signal indicative of a travel speed of the machine, and a controller configured to activate the steering actuator to move the traction device an amount based on the first and second signals and to activate the feedback actuator to urge the operator input device toward the neutral position based on the third signal.

### TECHNICAL FIELD

The present disclosure relates generally to a steering control system and, more particularly, to a steering control system having speed-based centering.

### BACKGROUND

Mobile machines, including wheel loaders, haul trucks, motor graders, and other types of heavy equipment, are often equipped with hydraulic and/or electric actuators that facilitate steering of the machines. For example, a particular machine may include an articulated joint and one or more associated hydraulic cylinders connected between frame members of the machine on either side of the joint. In response to an operator input to a control system, the hydraulic cylinders are caused to expand and retract and thereby pivot a forward end of the machine about the articulated joint relative to a back end of the machine to steer the machine. In another example, the same or a different machine may include one or more wheels that pivot at a vertical joint between the wheel and the frame. In this example, one or more hydraulic cylinders may be connected between the wheel and the frame of the machine and caused to expand and retract in response to operator input to a control system, thereby causing the wheel to pivot about the joint and steer the machine.

The steering of the machine may be controlled through a number of different strategies. One strategy includes controlling an actual steering angle of the machine based on a positional input from the operator. In other words, as the operator turns a steering wheel or tilts a joystick lever to a particular angle away from a neutral position, a signal indicative of a desired steering angle is generated and directed to a steering controller. The controller then regulates operation of the actuator at the articulated joint or wheel to pivot to a corresponding angle, as measured by a steering sensor.

During the position-based steering described above, it may be beneficial to provide tactile feedback to the operator of the machine regarding steering and to cause the steering wheel or joystick to self-center back to the neutral position when released. Tactile feedback may allow an operator to more accurately track an actual steering angle of the machine and thereby better control the machine. The return-to-center of the steering wheel or joystick may help to reduce operator fatigue and improve stability at high speeds.

An exemplary steering system is disclosed in U.S. Pat. No. 6,910,699 (the '699 patent) by Cherney that issued on Jun. 28, 2005. In particular, the '699 patent discloses a machine steering wheel having a shaft connected to a steering angle encoder, a steering actuator, a magnetorheological brake connected to the shaft, and a controller in communication with the encoder, the actuator, and the brake. The controller is configured to command the actuator to vary a vehicle steering angle in response to the rotational position of the shaft, as sensed by the encoder. The controller is also configured to command the brake to vary a resistance to the steering shaft rotation as a function of the rotational position of the shaft and a machine travel speed, thereby providing tactile feedback to the operator regarding steering.

Although the steering system of the '699 patent may provide tactile feedback during steering by increasing a resistance to steering shaft rotation, the system may not have the capability of centering the steering wheel. Accordingly, an operator of the steering system of the '699 patent may still experience fatigue caused by extended periods of machine operation, as well as instabilities at high speeds.

The disclosed steering control system is directed to overcoming one or more of the problems set forth above and/or other problems of the prior art.

### SUMMARY OF THE INVENTION

In one aspect, the present disclosure is directed to a steering control system for a machine having a traction device. The steering control system may include a steering actuator operatively connected to the traction device and configured to move the traction device to steer the machine, and a steering sensor associated with at least one of the traction device and the steering actuator and configured to generate a first signal indicative of an actual steering angle of the machine. The steering control system may also include an operator input device movable through a range from a neutral position to a maximum displaced position by an operator of the machine, and an input sensor associated with the operator input device and configured to generate a second signal indicative of desired steering of the machine. The steering control system may further include a feedback actuator operatively connected to the operator input device, a travel speed sensor configured to generate a third signal indicative of a travel speed of the machine, and a controller in communication with the steering actuator, the steering sensor, the input sensor, the feedback actuator, and the travel speed sensor. The controller may be configured to activate the steering actuator to move the traction device an amount based on the first and second signals, and to activate the feedback actuator to urge the operator input device toward the neutral position based on the third signal.

In another aspect, the present disclosure is directed to a method of steering a machine having a traction device. The method may include monitoring operator manipulation of a steering device, monitoring an actual machine steering angle, and monitoring a travel speed of the machine. The method may further include steering the at least one traction device based on a position of the steering device and the actual machine steering angle, and urging the steering device toward a neutral position based on the travel speed.

### BRIEF DESCRIPTION OF THE DRAWINGS

FIG. 1 is a diagrammatic illustration of an exemplary disclosed machine;

FIG. 2 is a schematic and diagrammatic illustration of an exemplary disclosed steering control system for the machine of FIG. 1; and

FIGS. 3-5 are graphs illustrating different operations that may be performed by the steering control system of FIG. 2.

### DETAILED DESCRIPTION

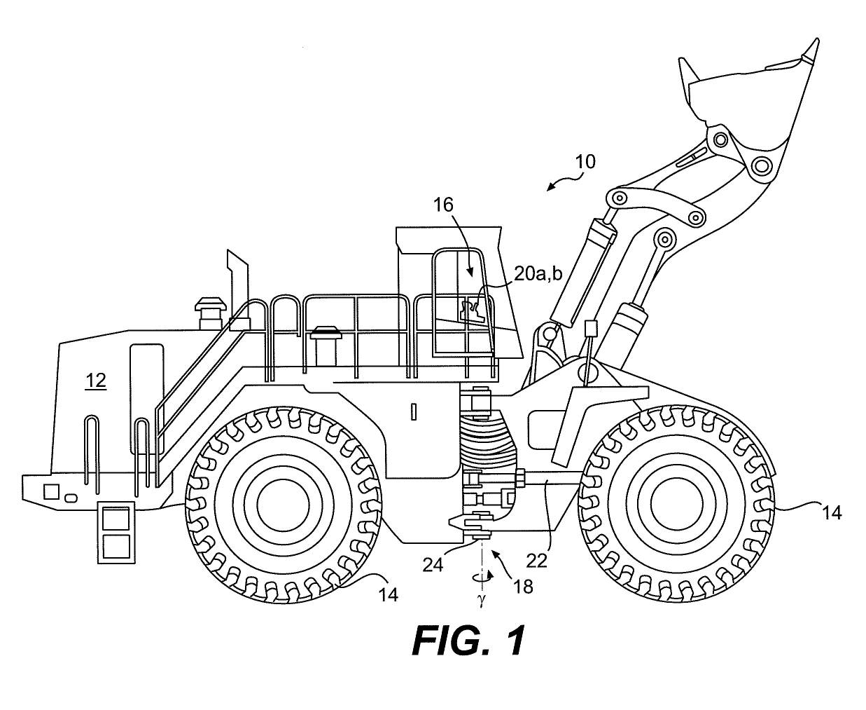

FIG. 1 illustrates an exemplary embodiment of a machine 10. Machine 10 may be a mobile machine that performs some type of operation associated with an industry such as mining, construction, farming, or another industry known in the art. For example, machine 10 may be an earth moving machine such as a wheel loader, a haul truck, a backhoe, or a motor grader. Machine 10 may include a power source 12 configured to drive a plurality of traction devices 14, an operator cabin 16 operatively supported by traction devices 14 (e.g., by way of a frame member), and a steering mechanism 18 configured to move a fore-located traction device 14 relative to an aft-located traction device 14 and thereby steer machine 10.

Power source 12 may embody an engine such as, for example, a diesel engine, a gasoline engine, a gaseous fuel powered engine such as a natural gas engine, or any other type of engine apparent to one skilled in the art. Power source 12 may alternatively embody a non-combustion source of power such as a fuel cell, a power storage device, an electric motor, or other similar mechanism. Power source 12 may be connected to drive traction device 14 to thereby propel machine 10.

Traction device 14 may include wheels located on each side of machine 10 (only one side shown). Alternately, traction device 14 may include tracks, belts or other known traction devices. It is contemplated that any of the wheels on machine 10 may be driven and/or steered.

Operator cabin 16 may include devices that receive input from a machine operator indicative of desired machine steering. Specifically, operator cabin 16 may include one or more operator input devices 20 such as steering wheels 20a, single or multi-axis joysticks 20b, or other known steering devices located proximate an operator seat. Operator input devices 20 may be proportional-type controllers that are movable through a range from a neutral position to a maximum displaced position to generate steering position signals that are indicative of desired machine steering. For the purposes of this disclosure, the neutral position of operator input device 20, may be considered the position at which no signals indicative of desired steering are generated. In other words, the neutral position of operator input device 20 may correspond with generally straight travel of machine 10.

Steering mechanism 18 may include one or more hydraulic cylinders 22 located on each side of machine 10 (only one side shown in FIG. 1) that function in cooperation with a centrally-located articulated joint 24. To affect steering, the hydraulic cylinder 22 located on one side of machine 10 may extend while the hydraulic cylinder 22 located on the opposite side of machine 10 simultaneously retracts, thereby causing fore-located traction devices 14 to pivot about articulated joint 24 relative to aft-located traction devices 14. It is contemplated that steering mechanism 18 may include a greater or lesser number of hydraulic cylinders 22 and/or that a different configuration of hydraulic cylinders 22 may be implemented, such as a direct connection to one or more traction devices 14 of machine 10. It is further contemplated that steering mechanism 18 may include steering actuators other than hydraulic cylinders such as, for example, electric or hydraulic motors, if desired.

The extension and retraction of hydraulic cylinders 22 may be affected by creating an imbalance of force on a piston assembly (not shown) disposed within a tube (not shown) of each hydraulic cylinder 22. Specifically, each of hydraulic cylinders 22 may include a first chamber (not shown) and a second chamber (not shown) separated by the piston assembly. The piston assembly may include two opposing hydraulic surfaces, one associated with each of the first and second chambers. The first and second chambers may be selectively supplied with a pressurized fluid and drained of the pressurized fluid to create an imbalance of force on the two surfaces that causes the piston assembly to axially displace within the tube and thereby steer machine 10.

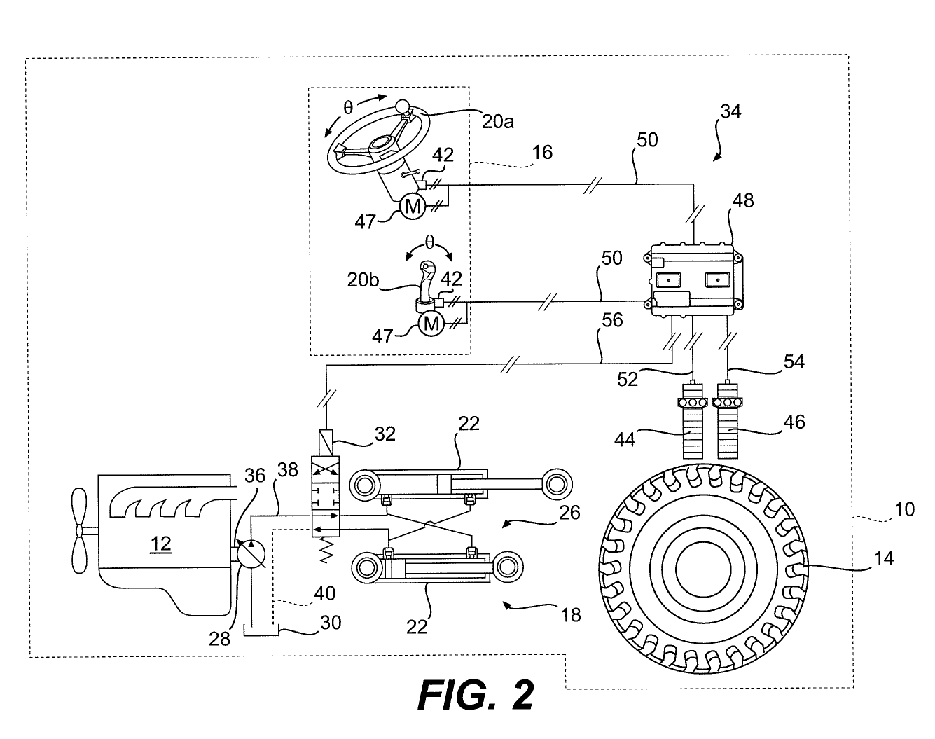

As illustrated in FIG. 2, machine 10 may also include a hydraulic circuit 26 configured to selectively fill and drain the pressure chambers of hydraulic cylinders 22, thereby steering machine 10. Hydraulic circuit 26 may include a source 28 of pressurized fluid, a tank 30, a steering control valve 32, and a steering control system 34. It is contemplated that hydraulic circuit 26 may include additional or different components than those illustrated in FIG. 2 and listed above such as, for example, accumulators, check valves, pressure relief or makeup valves, pressure compensating elements, restrictive orifices, and other hydraulic components known in the art.

Source 28 may produce a flow of pressurized fluid and include a variable displacement pump, a fixed displacement pump, a variable flow pump, or another source of pressurized fluid known in the art. Source 28 may be drivably connected to power source 12 by, for example, a countershaft 36, a belt (not shown), an electric circuit (not shown), or in any other suitable manner. Although FIG. 2 illustrates source 28 as being dedicated to supplying pressurized fluid to only hydraulic circuit 26, it is contemplated that source 28 may alternatively supply pressurized fluid to additional machine hydraulic circuits.

Tank 30 may embody a reservoir configured to hold a supply of fluid. The fluid may include, for example, an engine lubrication oil, a transmission lubrication oil, a separate hydraulic oil, or any other fluid known in the art. Source 28 may draw fluid from and return fluid to tank 30. It is contemplated that source 28 may be connected to multiple separate fluid tanks, if desired.

Steering control valve 32 may fluidly communicate hydraulic cylinders 22 with source 28 and tank 30. Specifically, steering control valve 32 may selectively connect the first and second chambers of hydraulic cylinders 22 with source 28 via a supply line 38, and with tank 30 via a drain line 40 to control actuation of hydraulic cylinders 22. Steering control valve 32 may include at least one valve element that functions to meter pressurized fluid to one of the first and second chambers within hydraulic cylinder 22, and to simultaneously allow fluid from the other of the first and second chambers to drain to tank 30. In one example, the valve element of steering control valve 32 may be solenoid-actuated against a spring bias to move between a first position at which fluid is allowed to flow into one of the first and second chambers while allowing the fluid to drain from the other of the first and second chambers to tank 30, a second position at which the flow directions are reversed, and a third neutral position at which fluid flow is substantially blocked from both of the first and second chambers to thereby lock hydraulic cylinders 22. The location of the valve element between the first, second, and third positions may determine a flow rate of the pressurized fluid into and out of the associated first and second chambers and a corresponding steering velocity (i.e., the time derivative of a steering angle) of steering mechanism 18. It is contemplated that one steering control valve 32 may regulate the filling and draining functions for both hydraulic cylinders 22 of machine 10 or, alternatively, that a separate steering control valve 32 may be associated with each hydraulic cylinder 22. It is also contemplated that steering control valve 32 may alternatively be replaced with multiple independent metering valves that separately control the filling and draining functions of each of the first and second chambers for each hydraulic cylinder 22, if desired. It is further contemplated that steering control valve 32 may alternatively be hydraulically actuated, mechanically actuated, pneumatically actuated, or actuated in any other suitable manner.

Steering control system 34 may include components in communication with hydraulic circuit 26, operator cabin 16, and traction device 14 of machine 10 that facilitate steering control of machine 10. In particular, steering control system 34 may include a steering input sensor 42 associated with operator input device 20, a travel speed sensor 44 associated with traction device 14, a steering sensor 46 associated with steering mechanism 18, a feedback actuator 47 associated with input device 20, and a controller 48 in communication with each of the sensors and actuators.

Input sensor 42 may directly or indirectly monitor operator manipulation of the associated input device 20, and generate a signal substantially proportional to the manipulation and indicative of a desired steering angle. For example, steering input sensor 42 may embody a position sensor configured to monitor a rotational or tilt displacement angle θ of the associated operator input device 20 away from its neutral position and to generate a corresponding displacement signal. The signal generated by input sensor 42 may be directed to controller 48 for further processing. It is contemplated that, instead of separate stand-alone components, input sensors 42 may alternatively form an integral portion of operator input devices 20, if desired.

Travel speed sensor 44 may embody a magnetic pickup-type sensor associated with traction device 14 or another drive train component of machine 10 to sense a rotational speed thereof and produce a corresponding speed signal. For example, travel speed sensor 44 may include a hall-effect element disposed proximate a magnet (not shown) embedded within a driveshaft of traction device 14, proximate a magnet (not shown) embedded within a component directly or indirectly driven by the drive shaft, or in other suitable manner to sense a rotational speed of traction device 14 and produce a corresponding speed signal. It is contemplated that travel speed sensor 44 could alternatively embody another type of speed sensor that directly or indirectly senses or monitors travel speed such as, for example, a laser sensor, a radar sensor, or other type of speed sensing device, which may or may not be associated with a rotating component. The signal generated by travel speed sensor 44 may be directed to controller 48 for further processing.

Steering sensor 46 may be associated with steering mechanism 18 to produce a signal indicative of the actual orientation of traction device 14. For example, steering sensor 46 may embody a displacement angle sensor associated with articulation joint 24 (referring to FIG. 1) and configured to determine a steering angle γ between the front end of machine 10 and the back end of machine 10, in a manner similar to steering input sensor 42 described above. Alternatively, steering sensor 46 may be an extension sensor associated with one or both of hydraulic cylinders 22 and configured to measure an extension amount of hydraulic cylinders 22, the extension measurement subsequently utilized to calculate the steering angle γ. Alternatively, in the embodiment where cylinders 22 are directly connected to traction devices 14, steering sensor 46 could be disposed proximate one or both of the pivot joints about which traction devices 14 are steered to determine a steering angle γ between traction devices 14 and a travel direction of machine 10. The signal generated by steering sensor 46 may be directed to controller 48 for further processing.

Feedback actuator 47 may embody any actuation component associated with operator input device 20 that can be used to apply tactile feedback and centering forces to this device based on commands from controller 48. In the disclosed example, feedback actuator 47 is shown as an electric motor that is configured to generate varying levels of torque to resist displacing movements of operator input device 20 away from the neutral position and to urge operator input device 20 to return to the neutral position after being released by an operator. It is contemplated that feedback actuator 47 may alternatively be a hydraulic actuator, include a friction brake, or utilize any other technology known in the art, as long as the actuator can produce a variable torque output in opposing directions that continues after release by the operator.

Controller 48 may embody a single microprocessor or multiple microprocessors that include a means for controlling an operation of steering control system 34. Numerous commercially available microprocessors can be configured to perform the functions of controller 48 and it should be appreciated that controller 48 could readily embody a general machine microprocessor capable of controlling numerous machine functions. Controller 48 may include a memory, a secondary storage device, a processor, and any other components for running an application. Various other circuits may be associated with controller 48 such as power supply circuitry, signal conditioning circuitry, solenoid driver circuitry, and other types of circuitry.

Controller 48 may receive the angular displacement signal generated by input sensor 42 and regulate operations of steering control valve 32 in response to the received signal. In particular, in response to a steering wheel or joystick displacement input from an operator, controller 48 may reference a map (not shown) stored in the memory thereof to determine a corresponding steering angle position and/or velocity command for steering control valve 32 that results in an operator desired steering of machine 10 (e.g., controller 48 may implement open-loop steering control). This reference map may include a collection of data in the form of tables, graphs, and/or equations. Alternatively or additionally, controller 48 may implement closed-loop steering control, where machine 10 is incrementally steered based on a difference between desired and actual steering angles, as measured by input and steering sensors 42 and 46, if desired.

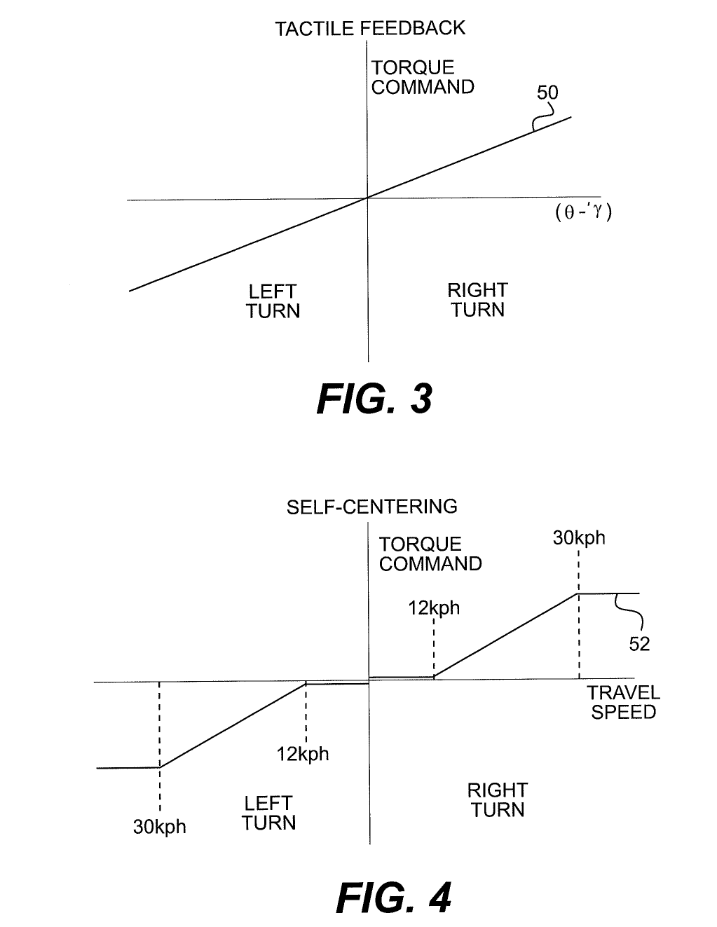

Controller 48 may selectively activate feedback actuator 47 based on the steering of machine 10. Specifically, controller 48 may be configured to cause feedback actuator 47 to apply a resistive torque to operator input device 20 that is substantially proportional to an amount of steering change requested by the operator. In other words, as a difference between the desired steering angle (measured as displacement angle θ by input sensor 42) increases relative to the actual steering angle (measured as displacement angle γ by steering sensor 46), controller 48 may command a greater resistive torque be applied by feedback actuator 47 to operator input device 20. This torque may serve only to resist the movement of input device 20 by an operator, and substantially diminish after the operator releases input device 20. The relationship between requested steering change (θ−γ) and resistive torque command directed from controller 48 to feedback actuator 47 may be contained within a control map stored in the memory of controller 48 and represented by a curve 50 shown in FIG. 3. In the disclosed embodiment, this relationship is linear. It should be noted, however, that the requested steering change/resistive torque command relationship may alternatively be non-linear, if desired.

Controller 48 may also selectively activate feedback actuator 47 based on the travel speed of machine 10. Specifically, controller 48 may be configured to cause feedback actuator 47 to apply a self-centering torque to operator input device 20 that urges operator input device 20 to return to their neutral positions, with the self-centering torque being substantially proportional to the travel speed of machine 10. In other words, as the travel speed of machine 10 (as measured by travel speed sensor 44) increases, controller 48 may command a greater self-centering torque be applied by feedback actuator 47 to return operator input device 20 to their neutral positions. This relationship may be contained within a control map stored in the memory of controller 48 and represented by a curve 52 shown in FIG. 4. The self-centering torque applied by feedback actuator 47 based on the travel speed of machine 10 may be additive to the resistive torque applied based on the requested steering change (θ−γ) during operator manipulation of input device 20, continue after release of input devices 20 by the operator, and be sufficient to fully return input device 20 to their neutral positions.

As shown in FIG. 4, the self-centering torque of feedback actuator 47 may only be present when the travel speed of machine 10 is greater than a non-zero threshold, for example about 12 kph. This threshold speed may represent a transition point between different classes of operations such as loading and roading. When loading, the travel speeds of machine 10 may generally stay below the threshold and it may be desirable for operator input device 20 to remain at a displaced position for an extended period of time to enable precise control over machine maneuvering. When roading, however, the travel speeds of machine 10 may be above the threshold and operation of machine 10 may benefit from the self-centering torque applied by feedback actuator 47. Although the self-centering torque applied by feedback actuator 47 may be substantially proportional to travel speed during a majority of machine operations, it is contemplated that a maximum torque limit may eventually be reached as machine travel speed continues to increase. In one example, the maximum self-centering torque limit may be reached at about 30 kph. This maximum self-centering torque limit may help to limit operator fatigue caused by feedback actuator 47. Similar to curve 50, it is contemplated that curve 52 may be linear or non-linear, as desired.

The torque applied by feedback actuator 47 based on the requested steering change (θ−γ) (i.e., the tactile feedback torque that only resists movement of input device 20) may be reduced to about zero when operator input device 20 is released by an operator and during its return to the neutral positions by the self-centering torque. That is, as operator input device 20 is returned to the neutral positions by the self-centering torque of feedback actuator 47, the desired steering angle may decrease along with the displacement position of operator input device 20, until the desired steering angle eventually matches the actual steering angle. At this point in time, the requested steering change may become substantially zero, making the tactile feedback torque commanded of feedback actuator 47, based on the requested steering change, also substantially zero. It should be noted that the self-centering torque command of feedback actuator 47 that is based on travel speed may still be non-zero at this time (i.e., until operator input device 20 is fully returned to its neutral position).

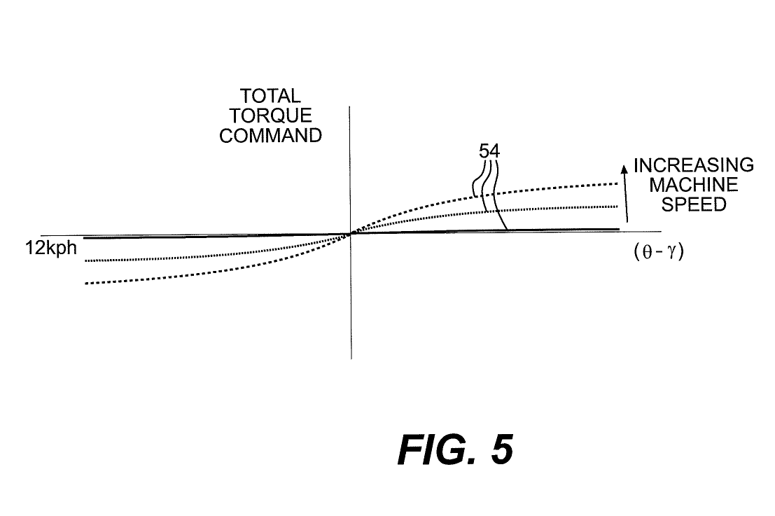

FIG. 5 shows an alternative map that may be stored in the memory of and referenced by controller 48 to determine a total torque command (resistive+self-centering torque command) directed to feedback actuator 47. In this map, the desired steering change (θ−γ) and travel speed may be directly related to the total torque command in a single map. Specifically, FIG. 5 illustrates multiple curves 54, each corresponding to a different travel speed. During operation, controller 48 may select the appropriate curve 54 corresponding with the current travel speed of machine 10, and then locate the horizontal coordinate in the map of FIG. 5 corresponding with the requested steering change to determine the corresponding total torque command from the vertical axis. When machine 10 is traveling at a speed between, less than, or greater than two speeds represented by curves 54 in the map of FIG. 5, the corresponding torque commands may be interpolated or extrapolated to obtain the appropriate torque command directed to feedback actuator 47.

### INDUSTRIAL APPLICABILITY

The disclosed steering control system may be applicable to any mobile machine where improved steering control is desirable. The disclosed steering control system may provide for tactile feedback and return-to-center functionality of input devices used to steer a machine, which may improve stability, control, and operator comfort. In addition, the disclosed steering control system may utilize common hardware to facilitate the tactile feedback and return-to-center functionality, thereby providing for a simplified system.

It will be apparent to those skilled in the art that various modifications and variations can be made to the disclosed steering control system without departing from the scope of the invention. Other embodiments of the steering control system will be apparent to those skilled in the art from consideration of the specification and practice of the steering control system disclosed herein. For example, it is contemplated that one or more features of the disclosed steering control system such as the tactile feedback and/or self-centering features may be associated with an operator activation switch, if desired. In this example, the operator may be able to select when these features are activated. It is also contemplated that the operator may be able to modify and/or select different steering control maps used to implement the tactile and/or self-centering features to better suit particular applications, as desired. It is intended that the specification and examples be considered as exemplary only, with a true scope being indicated by the following claims and their equivalents.

What is claimed is:

1. A steering control system for a machine having a traction device, comprising:
a steering actuator operatively connected to the traction device and configured to move the traction device to steer the machine;
a steering sensor associated with at least one of the traction device and the steering actuator and configured to generate a first signal indicative of an actual steering angle of the machine;
an operator input device movable through a range from a neutral position to a maximum displaced position by an operator of the machine;
an input sensor associated with the operator input device and configured to generate a second signal, the second signal being indicative of desired steering of the machine;
a feedback actuator operatively connected to the operator input device;
a travel speed sensor configured to generate a third signal indicative of a travel speed of the machine; and
a controller in communication with the steering actuator, the steering sensor, the input sensor, the feedback actuator, and the travel speed sensor, the controller being configured to:
activate the steering actuator to move the traction device an amount based on the first and second signals; and
activate the feedback actuator to urge the operator input device toward the neutral position based on the third signal.

2. The steering control system of claim 1, wherein when the operator input device is released by the operator, a force on the operator input device generated by the feedback actuator based on the third signal is sufficient to return the operator input device to the neutral position.

3. The steering control system of claim 2, wherein the force on the operator input device generated by the feedback actuator based on the third signal is about zero when the travel speed of the machine is below a threshold while the machine is traveling.

4. The steering control system of claim 3, wherein the force generated by the feedback actuator based on the third signal remains non-zero and increases proportional to the travel speed when the travel speed of the machine is above the threshold.

5. The steering control system of claim 3, wherein the controller is further configured to activate the feedback actuator to resist movement of the operator input device based on the first and second signals.

6. The steering control system of claim 5, wherein a force generated by the feedback actuator based on the first and second signals increases as a travel speed of the machine increases.

7. The steering control system of claim 6, wherein the force generated by the feedback actuator based on the first and second signals is proportional to a difference between the actual machine steering and the desired machine steering.

8. The steering control system of claim 6, wherein the controller includes stored in memory a map relating a displacement position of the operator input device, a machine travel speed, and a force command for the feedback actuator.

9. The steering control system of claim 1, wherein the steering actuator includes a pair of hydraulic cylinders located on opposing sides of an articulation joint.

10. The steering control system of claim 1, wherein the controller is configured to relate a displacement position of the operator input device away from the neutral position directly to a desired position of the steering actuator.

11. The steering control system of claim 1, wherein the operator input device is a joystick.

12. The steering control system of claim 1, wherein the feedback actuator is an electric motor.

13. A method of steering a machine having a traction device, the method comprising:
sensing operator manipulation of a steering device;
sensing an actual machine steering angle;
sensing a travel speed of the machine;
steering the traction device based on a position of the steering device and the actual machine steering angle; and
urging the steering device toward a neutral position based on the travel speed.

14. The method of claim 13, wherein urging the steering device includes generating a first force sufficient to return the steering device to the neutral position when the steering device is released by the operator.

15. The method of claim 14, wherein returning the steering device to the neutral position includes returning the steering device to the neutral position only when a speed of the machine is greater than a threshold.

16. The method of claim 14, wherein the first force is non-zero and substantially proportional to the travel speed when the travel speed of the machine is above the threshold.

17. The method of claim 16, further including generating a second force that resists operator movement of the steering device away from the neutral position based on a difference between desired machine steering and actual machine steering.

18. The method of claim 17, wherein the second force increases as travel speed of the machine increases.

19. The method of claim 13, wherein steering the traction device includes relating a displacement position of the steering device directly to a desired position of the traction device.

20. A machine, comprising:
an engine;
a traction device driven by the engine to propel the machine;
a steering actuator operatively connected to the traction device and powered by the engine to move the traction device and steer the machine;
a steering sensor associated with the traction device and configured to generate a first signal indicative of an actual steering angle of the machine;
an operator cabin operatively supported by the traction device;
an operator input device disposed within the operator cabin and movable through a range from a neutral position to a maximum displaced position;
an input sensor associated with the operator input device and configured to generate a second signal indicative of a displacement position of the operator input device away from the neutral position;
a feedback actuator operatively connected to the operator input device and configured to generate a force on the operator input device that urges the operator input device toward the neutral position;
a travel speed sensor configured to generate a third signal indicative of a travel speed of the machine; and
a controller in communication the steering sensor, the input sensor, the feedback actuator, and the travel speed sensor, the controller being configured to:
control the steering actuator to move the traction device an amount based on the first and second signals;
activate the feedback actuator to move the operator input device toward the neutral position based on the third signal; and
activate the feedback actuator to resist movement of the operator input device by the operator based on the first and second signals.
